(19) United States
(12) Patent Application Publication
(10) Pub. No.: US 2011/0115889 A1
(43) Pub. Date: May 19, 2011

(54) METHOD OF DRIVING LIGHT SOURCE AND DISPLAY APPARATUS FOR PERFORMING THE METHOD

(75) Inventors: Bo-Ram KIM, Asan-si (KR); Myoung-Chul KIM, Dongducheon-si (KR); Yun-Jae KIM, Asan-si (KR); Byoung-Jun LEE, Cheonan-si (KR); Nam-Hee GOO, Gunsan-si (KR); Seung-Hwan MOON, Asan-si (KR); Kyung-Uk CHOI, Asan-si (KR); Hyun-Seok KO, Seoul (KR)

(73) Assignee: SAMSUNG ELECTRONICS CO., LTD., Suwon-si (KR)

(21) Appl. No.: 12/824,315

(22) Filed: Jun. 28, 2010

(30) Foreign Application Priority Data
Nov. 13, 2009 (KR) 2009-0109843

(51) Int. Cl. H04N 13/04; G09G 5/10

(52) U.S. Cl. 348/56; 345/690; 348/E13.075

(57) ABSTRACT

A method of driving a light source including a light source part includes determining whether an image signal is a two-dimensional mode image signal or a three-dimensional mode image signal to generate a mode signal, adjusting a level of a current to be applied to the light source part in response to the mode signal to generate an adjusted current, and driving the light source part using the adjusted current.

This application claims priority to Korean Patent Application No. 2009-0109843, filed on Nov. 13, 2009, and all the benefits accruing therefrom under 35 U.S.C. §119, the content of which in its entirety is herein incorporated by reference.

### BACKGROUND OF THE INVENTION

(1) Field of the Invention

The present invention relates to a method of driving a light source and a display apparatus for performing the method. More particularly, the present invention relates to a method of driving a light source that substantially improves display quality, and a display apparatus for performing the method.

(2) Description of the Related Art

Generally, a display apparatus displays a two-dimensional (“2D”) image. Recently however, a stereoscopic image display apparatus for displaying a three-dimensional (“3D”) stereoscopic image has been developed due to increasing demand for 3D stereoscopic images displayed in games and movies, for example. The stereoscopic image display apparatus typically supplies 2D flat images that are different from each other to each of a user's eyes such that the user perceives a 3D stereoscopic image. Specifically, the user views one of the two different 2D flat images with each eye and the user's brain thereby synthesizes the pair of 2D flat images such that they are perceived as a stereoscopic 3D image.

A stereoscopic 3D image display apparatus may be classified as either a stereoscopic type or an auto-stereoscopic type display apparatus, depending on whether an extra spectacle is required. More specifically, the stereoscopic type display apparatus also includes an anaglyph type display apparatus and a liquid crystal shutter stereoscopic type display apparatus, for example. In the anaglyph type display apparatus, a viewer wears a pair of glasses fitted with one red lens and one blue lens. In the shutter stereoscopic type display apparatus, a left image and a right image are temporally divided and are periodically displayed, and the viewer wears a pair of glasses in which an opening and closing of a left-eye liquid crystal shutter and a right-eye liquid crystal shutter are synchronized with a period of the display of the left and right images.

The stereoscopic 3D image display apparatus, which typically employs the liquid crystal shutter stereoscopic type, alternately displays a left-eye image and a right-eye image on a display panel, and a liquid crystal shutter attached to a pair of glasses opens and closes in synchronization with an image displayed on the display panel, so that a 3D stereoscopic image can be viewed.

### BRIEF SUMMARY OF THE INVENTION

Exemplary embodiments of the present invention provide a method of driving a light source that substantially enhances a display quality of a three-dimensional (“3D”) image.

Exemplary embodiments of the present invention also provide a display apparatus for performing the method.

According an exemplary embodiment of the present invention, in a method of driving a light source that includes a light source part, the method includes determining whether an image signal is a two-dimensional mode image signal or a three-dimensional mode image signal to generate a mode signal, adjusting a level of a current to be applied to the light source part in response to the mode signal to generate an adjusted current, and driving the light source part using the adjusted current.

The adjusting the level of the current to be applied to the light source part may include: adjusting a first current to have a first level when the mode signal is a two-dimensional mode; and adjusting a second current to have a second level, which is greater than the first level, when the mode signal is a three-dimensional mode.

The light source part may include a light-emitting string including light-emitting diodes.

The light source part may include light-emitting strings connected in electrical parallel with each other, and each string may include light-emitting diodes connected in electrical series with each other.

The method may further include selectively opening and closing a first shutter and a second shutter of an eyeglasses part when the image signal is the three-dimensional mode image signal.

The method may further include, temporally dividing the three-dimensional mode image signal into a left-eye image and a right-eye image, and displaying temporally divided images using light provided from the light source part.

The displaying the temporally divided images may include: opening the first shutter and closing the second shutter when the left-eye image is displayed; and closing the first shutter and opening the second shutter when the right-eye image is displayed.

In another exemplary embodiment of the present invention, a display apparatus includes: a mode determining part which determines whether an image signal is a two-dimensional mode image signal or a three-dimensional mode image signal to generate a mode signal; a light source part comprising a light-emitting string including light-emitting diodes; and a light source driving part which adjusts a level of a current applied to the light source part in response to the mode signal to drive the light-emitting string using an adjusted current.

The light source driving part may include: a current adjusting part which adjusts the level of the current in response to the mode signal; and an integrated circuit electrically connected to a first terminal of the light-emitting string. The integrated circuit may supply the adjusted current to the light-emitting string.

The integrated circuit may include a current control terminal, and the current adjusting part may include: a first resistor connected to the current control terminal; a switch including a control electrode which receives the mode signal and a first electrode connected to the first resistor; and a second resistor connected to a second electrode of the switch.

The switch may be turned off to supply a first current, having a first level based on the first resistor to the current control terminal, when the mode signal is a two-dimensional mode. The integrated circuit may supply the first current having the first level to the light-emitting string.

The switch may be turned on to supply a second current, having a second level based on the first resistor and the second resistor, which is connected in electrical parallel with the first resistor, to the current control terminal when the mode signal is a three-dimensional mode. The integrated circuit may supply the second current having the second level to the light-emitting string.

The second level is greater than the first level.

The display apparatus may further include a plurality of light emitting strings, and wherein the integrated circuit may include: a first channel terminal connected to a connection node which connects a first light-emitting string of the plurality of light emitting strings and a second light-emitting string of the plurality of light emitting strings; and a second channel terminal disposed adjacent to the first channel terminal. The current adjusting part may include a switch including a first electrode and a second electrode. The first electrode may be connected to a control electrode which receives the mode signal and the connection node, and the second electrode may be connected to the second channel terminal.

The switch may be turned off to electrically connect the connection node and the first channel terminal when the mode signal is the two-dimensional mode, and the integrated circuit may supply the first current having the first level to the first light-emitting string and the second light emitting string that are electrically connected to the connection node.

The switch may be turned on to connect to the first channel terminal and the second channel terminal in electrical parallel when the mode signal is the three-dimensional mode, and the integrated circuit may the second current having the second level to the first light-emitting string and the second light emitting string.

The display apparatus may further include: a display panel which displays a two-dimensional image when the mode signal is a two-dimensional mode, and which displays a three-dimensional image when the mode signal is a three-dimensional mode; an eyeglasses part comprising a left-eye lens part including a first shutter and a right-eye lens part including a second shutter; and a shutter control part selectively opening and closing the first shutter and the second shutter when the three-dimensional image is displayed on the display panel.

The display panel may temporally divide the image signal into a left-eye image and a right-eye image to display temporally divided images when the three-dimensional image is displayed on the display panel. The shutter control part may open the first shutter and close the second shutter when the left-eye image is displayed on the display panel. The shutter control part may close the first shutter and open the second shutter when the right-eye image is displayed on the display panel.

Thus, according to a method of driving a light source and display apparatus for performing the method according to one or more exemplary embodiments, a light source is driven by a current having a first level when a 2D image is displayed, and is driven by a current having a second level that is greater than the first level when a 3D image is displayed, thereby significantly enhancing luminance characteristics of the displayed 3D image.

### BRIEF DESCRIPTION OF THE DRAWINGS

The above and other advantages of the present invention will become more readily apparent by describing in further detail exemplary embodiments thereof with reference to the accompanying drawings, in which:

FIG. 1 is a block diagram of an exemplary embodiment of a display apparatus according to the present invention;

FIG. 2 is a block diagram of a light source driving part of the display apparatus shown in FIG. 1;

FIG. 3 is a flowchart illustrating an exemplary embodiment of a method of driving a light source apparatus according to the present invention;

FIG. 4 is a signal timing diagram showing a current level of a light source part of the display apparatus shown in FIG. 1;

FIG. 5 is a block diagram of another exemplary embodiment of a light source driving part according to the present invention; and

FIG. 6 is a flowchart illustrating another exemplary embodiment of a method of driving a light source apparatus according to the present invention.

### DETAILED DESCRIPTION OF THE INVENTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of the present invention will be described in further detail with reference to the accompanying drawings.

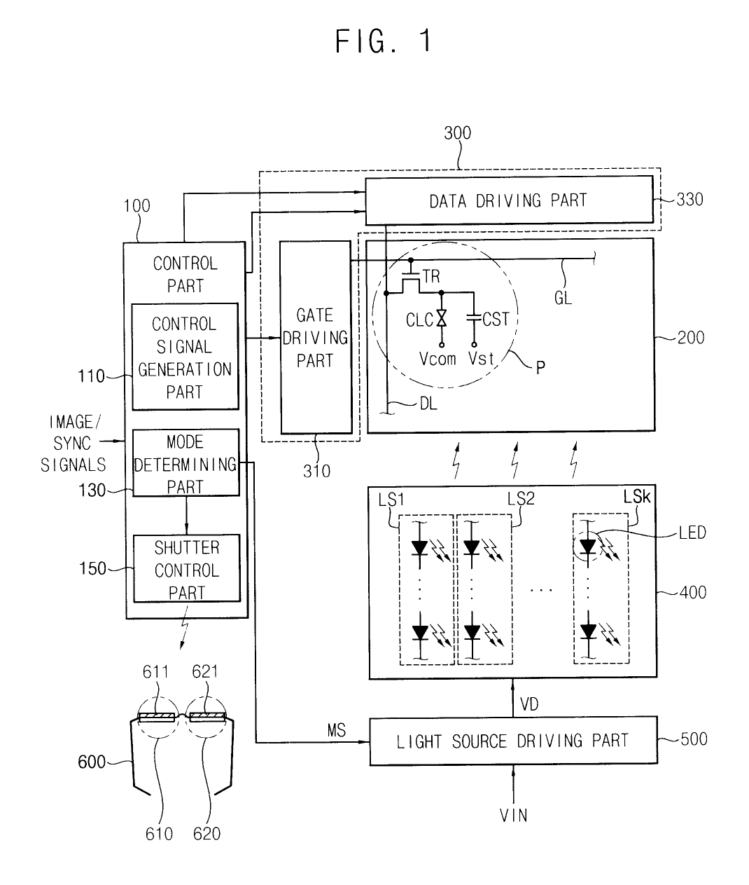

FIG. 1 is a block diagram of an exemplary embodiment of a display apparatus according to the present invention.

Referring to FIG. 1, the display apparatus includes a control part 100, a display panel 200, a panel driving part 300, a light source part 400, a light source driving part 500 and an eyeglasses part 600.

The control part 100 includes a control signal generation part 110, a mode determining part 130 and a shutter control part 150 and receives an image signal and a synchronization signal. The control part 100 controls the panel driving part 300, the light source driving part 500 and the eyeglasses part 600 based on the synchronization signal. In an exemplary embodiment, the control part 100 includes the control signal generation part 110, the mode determining part 130 and the shutter control part 150, but additional exemplary embodiments are not limited thereto. Specifically, for example, in one or more additional exemplary embodiments, the control signal generation part 110, the mode determining part 130 and/or the shutter control part 150 may be omitted from the control part 100.

The control signal generation part 110 generates a timing control signal for controlling a driving timing of the panel driving part 300 by using the synchronization signal. The synchronization signal includes a vertical synchronization signal, a horizontal synchronization signal and a system clock signal, for example. The vertical synchronization signal may represent a time for displaying one frame. The horizontal synchronization signal may represent a time for displaying one line of the one frame. Thus, the horizontal synchronization signal may include pulses corresponding to the number of pixels included in one line. In an exemplary embodiment, the timing control signal includes a horizontal start signal, a vertical start signal, a data clock signal and a gate clock signal, for example.

The mode determining part 130 obtains an image mode of the image signal received based on the synchronization signal, and generates a mode signal MS to provide the light source driving part 500 with the mode signal MS.

The shutter control part 150 controls an opening and closing of shutters of the eyeglasses part 600 in accordance with a three-dimensional image displayed on the display panel 200 based on the synchronization signal, as described in greater detail below.

Still referring to FIG. 1, the display panel 200 includes a plurality of pixels P displaying an image. Each pixel P of the plurality of pixels P includes a thin-film transistor (“TFT”) TR connected to a gate line GL and a data line DL, a liquid crystal capacitor CLC electrically connected to the TFT TR, and a storage capacitor CST electrically connected to the liquid crystal capacitor CLC. A common voltage Vcom is applied to a terminal of the liquid crystal capacitor CLC, and a storage voltage Vst is applied to a terminal of the storage capacitor CST. The display panel 200 displays a two-dimensional (“2D”) image or a three-dimensional (“3D”) image in accordance with the image mode of the image signal received based on the synchronization signal. More specifically, for example, the display panel 200 displays a 2D frame image when the image mode is 2D mode, while the display panel 200 temporally divides a left-eye image and a right-eye image to display a 3D image when the image mode is a 3D mode.

As shown in FIG. 1, the panel driving part 300 includes a gate driving part 310 and a data driving part 330. The gate driving part 310 generates a gate signal based on the timing control signal, and provides the gate line GL with the gate signal. The data driving part 330 converts the image signal, which is a digital signal, into an analog image signal based on the timing control signal, and provides the data line DL with the analog image signal.

As mentioned above, the panel driving part 300 displays a 2D image on the display panel 200 when the received image signal is the 2D mode. However, the panel driving part 300 alternately displays a left-eye image and a right-eye image on the display panel 200 when the image signal is the 3D mode.

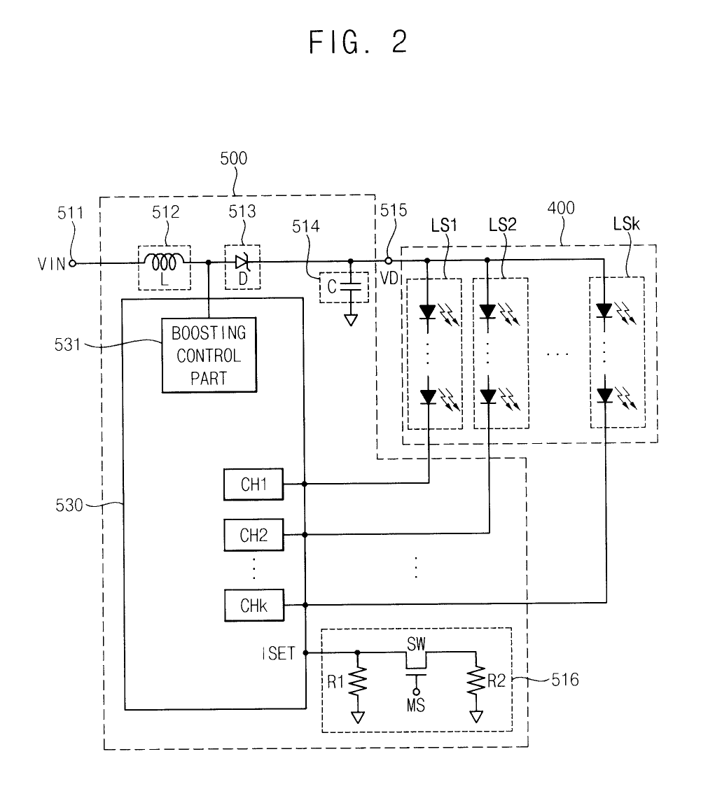

The light source part 400 provides the display panel 200 with light. The light source part 400 includes light-emitting strings LS1, LS2, . . . , LSk (where ‘k’ is a natural number). Each of the light-emitting strings LS1, LS2, . . . , LSk includes a light-emitting diodes (“LEDs”) that are connected in electrical series with each other, as shown in FIGS. 1 and 2.

The light source driving part 500 controls a current level applied to the light-emitting strings LS1, LS2, . . . , LSk based on the mode signal MS. For example, when the mode signal MS is at a low level, which, in an exemplary embodiment corresponds to the 2D mode, the light source driving part 500 provides the light-emitting strings LS1, LS2, . . . , LSk with a first current having a first level. When the mode signal MS is at a high level, which corresponds to the 3D mode, for example, the light source driving part 500 provides the light-emitting strings LS1, LS2, . . . , LSk with a second current, e.g., an adjusted current, having a second level. In an exemplary embodiment, the second level of the adjusted, second current is greater than the first level of the first current. As will be described in greater detail below with reference to FIGS. 1, 2 and 5, when the current applied to the light-emitting strings LS1, LS2, . . . , LSk is at the high level (e.g., the second level) and the mode signal MS transitions from the high level to the low level, the current applied to the light-emitting strings LS1, LS2, . . . , LSk is adjusted to be the low level (e.g., the first level). Thus, as used herein, the term “adjusted current” may apply to either or both the first current and the second current.

Still referring to FIG. 1, the eyeglasses part 600 includes a left-eye lens part 610 and a right-eye lens part 620. The left-eye lens part 610 includes a first shutter 611, which may be referred to as a left-eye shutter 611, and the right-eye lens part 620 includes a second shutter 621, which may be referred to as a right-eye shutter 621. The eyeglasses part 600 opens and closes the first shutter 611 and the second shutter 621 in accordance with a control operation and/or signal of the shutter control part 150.

More specifically, for example, when a left-eye image is displayed on the display panel 200, the first shutter 611 of the eyeglasses part 600 is opened and the second shutter 621 of the eyeglasses part 600 is closed during a vertical blank interval period. Similarly, when a right-eye image is displayed on the display panel 200, the second shutter 621 of the eyeglasses part 600 is opened and the first shutter 611 of the eyeglasses part 600 is closed during a vertical blank interval period. Thus, a viewer using the eyeglasses part 600 sees the left-eye image through the left-eye lens part 610 during a vertical blank interval period corresponding to the left-eye image, and sees the right-eye image through the right-eye lens part 620 during a vertical blank interval period corresponding to the right-eye image. Therefore, the viewer perceives, e.g., views, a 3D stereoscopic image on the display panel 200.

As discussed above, the viewer views a 3D stereoscopic image during the vertical blank interval period. Thus, in the 3D mode, the light source driving part 500 drives the light source part 400 with a high current, e.g., with the second current, and light emitted from the light source part 400 in the 3D mode has a high luminance, relative to a luminance during the 2D mode, and is provided to the display panel 200. As a result, a luminance of the 3D image, which is viewed during a short time (as compared to viewing time of the 2D image) is compensated.

FIG. 2 is a block diagram of the light source driving part 500 of the display apparatus shown in FIG. 1.

Referring to FIGS. 1 and 2, the light source driving part 500 includes an input part 511 (which, in an exemplary embodiment, is an input terminal 511), a boosting part 512, a rectifying part 513, a charging part 514, an output part 515 (which, in an exemplary embodiment, is an output terminal 515), a current adjusting part 516 and an integrated circuit (“IC”) 530. The light source driving part 500 drives the light source part 400 including the light-emitting strings LS, LS2, . . . , LSk.

The input part 511 receives an input voltage VIN.

The boosting part 512 includes an inductor L having a first terminal connected to the input terminal 511 and a second terminal connected to the rectifying part 513. The boosting part 512 boosts the input voltage VIN to generate a driving voltage VD in accordance with a control operation and/or signal of the integrated circuit 530.

The rectifying part 513 includes a diode D having a first terminal connected to the boosting part 512 and a second terminal connected to the output terminal 515. The rectifying part 513 rectifies the driving voltage VD.

The charging part 514 includes a capacitor C having a first terminal connected to the output terminal 515 and a second terminal connected to a ground potential, e.g., to ground, and charges the driving voltage VD.

The output terminal 515 outputs the driving voltage VD to the light source part 400. The output terminal 515 is commonly connected to first terminals of each of the light-emitting strings LS1, LS2, . . . , LSk to provide the light-emitting strings LS1, LS2, . . . , LSk with the driving voltage VD. Second terminals of each of the light-emitting strings LS1, LS2, . . . , LSk are respectively connected to channel terminals CH1, CH2, . . . , CHk of the integrated circuit 530.

In an exemplary embodiment, the current adjusting part 516 includes a first resistor R1, a switch SW and a second resistor R2. The first resistor R1 has a first terminal connected to the integrated circuit 530 and a second terminal connected to ground. The switch SW includes a first electrode connected to the first terminal of the first resistor R1 and a control electrode for receiving the mode signal MS. The second resistor R2 includes a first terminal connected to a second electrode of the switch SW and a second terminal connected to ground. When the switch SW is operated, e.g., is turned on and turned off, the current adjusting part 516 applies the first current having the first level and the second current having the second level, which is greater than the first level, to the integrated circuit 530.

More particularly, for example, when the mode signal MS is at a low level, the switch SW is turned off, and the first current, having the first level and which corresponds to the first resistor R1, is applied to the integrated circuit 530. Alternatively, when the mode signal MS is at a high level, the switch SW is turned on, and the second current, which has the second level and corresponds to the first resistor R1 as well as the second resistor R2, which are connected to each other in electrical parallel, is applied to the integrated circuit 530.

As shown in FIG. 2, the integrated circuit 530 includes a boosting control part 531, the channel terminals CH1, CH2, . . . , CHk and a current control terminal ISET. The boosting control part 531 is connected between the boosting part 512 and the rectifying part 513 to control a current that flows through the boosting part 512 to boost the input voltage VIN to generate the driving voltage VD. The channel terminals CH1, CH2, . . . , CHk are connected to second terminals of the light-emitting strings LS1, LS2, . . . , LSk, respectively. The integrated circuit 530 controls a current level that flows through each of the light-emitting strings LS1, LS2, . . . , LSk such that the current levels are uniform. In an exemplary embodiment, for example, driving signals applied to the light-emitting strings LS1, LS2, . . . , LSk may be pulse width modulation (“PWM”) signals, although additional exemplary embodiments are not limited thereto.

The current control part ISET is connected to the current adjusting part 516 to receive the current that is adjusted by the current adjusting part 516, e.g., to receive the first current or the second current, based on the mode signal MS, as discussed in greater detail above. Thus, the integrated circuit 530 controls the levels of currents flowing in each of the light-emitting strings LS1, LS2, . . . , LSk based on the level of the current received at the current control part ISET from the current adjusting part 516. More specifically, for example, when the first current, having the first level, is received at the current control part ISET, the integrated circuit 530 controls supplies the first current to each of the light-emitting strings LS1, LS2, . . . , LSk. On the other hand, when the second current, having the second level that is greater than the first level, is received at the current control terminal ISET, the integrated circuit 530 provides the second current to each of the light-emitting strings LS1, LS2, . . . , LSk.

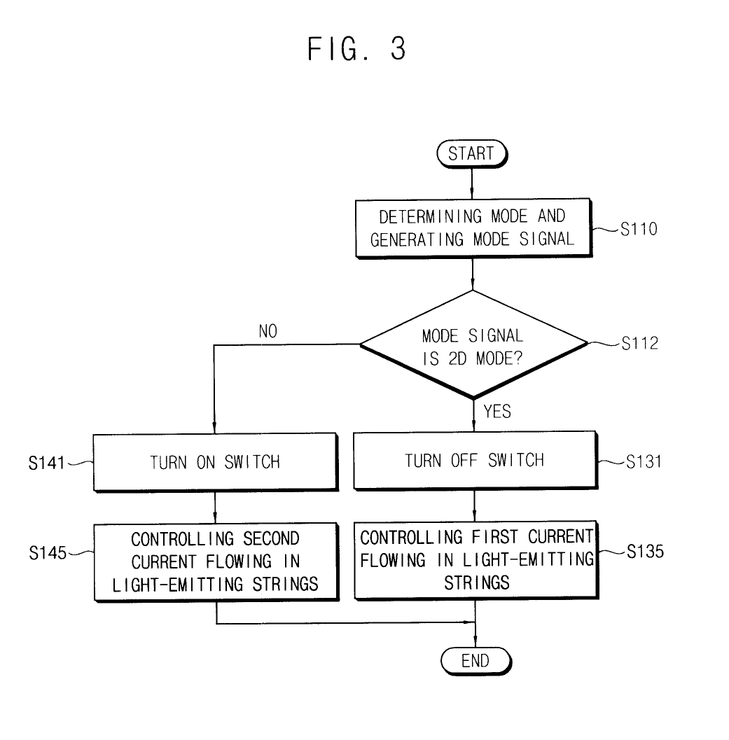

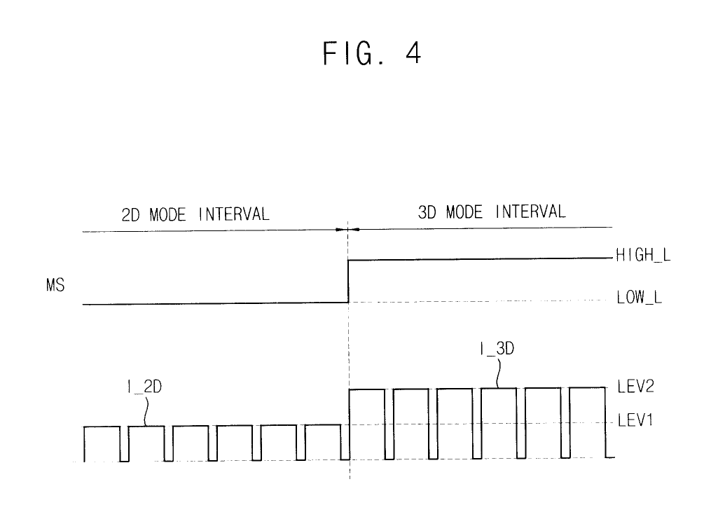

FIG. 3 is a flowchart illustrating an exemplary embodiment of a method of driving a light source apparatus according to the present invention. FIG. 4 is signal timing diagram showing a current level of a light source part of the display apparatus shown in FIG. 1.

Referring to FIGS. 1, 3 and 4, the mode determining part 130 determines an image mode of an image signal by using the synchronization signal to generate a mode signal MS (step S110). Specifically, for example, the mode determining part 130 generates the mode signal MS having a low level LOW_L when a mode of the image signal is a 2D mode, e.g., when the image signal is a 2D mode image signal. Alternatively, the mode determining part 130 generates the mode signal MS having a high level HIGH_L when a mode of the image signal is a 3D mode, e.g., when the image signal is a 3D mode image signal.

In step S112, it is determined whether the mode signal MS, which is generated in step S110, corresponds to the 2D mode or the 3D mode.

When the mode signal MS corresponds to the 2D mode, the mode determining part 130 provides the light source driving part 500 with the mode signal MS at the low level LOW_L. Thus, the mode signal MS at the low level LOW_L is supplied to a control electrode of the switch SW of the current adjusting part 516 (FIG. 2). Accordingly, the switch SW is turned off in response to the mode signal MS having the low level LOW_L (step S131). When the switch SW is turned off, the current control terminal ISET of the integrated circuit 530 receives a first current I_2D having a first level LEV1 based on the first resistor R1 (FIG. 2).

As a result, when the mode signal MS corresponds to the 2D mode, the integrated circuit 530 supplies the first current I_2D having the first level LEV1 to each of the light-emitting strings LS1, LS2, . . . , LSk connected to the channel terminals CH1, CH2, . . . , CHk, respectively, based on the first current I_2D of the first level LEV1 applied to the current control terminal ISET. Thus, each of the light-emitting stings LS1, LS2, . . . , LSk is driven by the first current I_2D having the first level LEV1.

On the other hand, when it is determined in step S112 that the mode signal MS corresponds to the 3D mode, the mode determining part 130 provides the light source driving part 500 with the mode signal MS at a high level HIGH_L. Thus, the mode signal MS at the high level HIGH_L is supplied to the control electrode of the switch SW of the current adjusting part 516.

Accordingly, the switch SW is turned on in response to the mode signal MS having the high level HIGH_L (step S141). When the switch SW is turned on, a second current I_3D having a second level LEV2, which is greater than the first level LEV1 due to the first resistor R1 and the second resistor R2, is applied to the current control terminal ISET.

As a result, the integrated circuit 530 supplies the second current I_3D having the second level LEV2 to the light-emitting strings LS1, LS2, . . . , LSk connected to the channel terminals CH1, CH2, . . . , CHk, respectively, based on the second current I_3D having the second level LEV2 that is applied to the current control terminal ISET (step S145). Thus, each of the light-emitting strings LS1, LS2, . . . , LSk is driven by the second current I_3D having the second level LEV2. As a result, in the 3D mode, the light-emitting strings LS1, LS2, . . . , LSk are driven by the second current I_3D having a current level that is greater than the current level in the 2D mode, and, accordingly, light having a higher luminance than in the 2D mode is generated by the light source part 400.

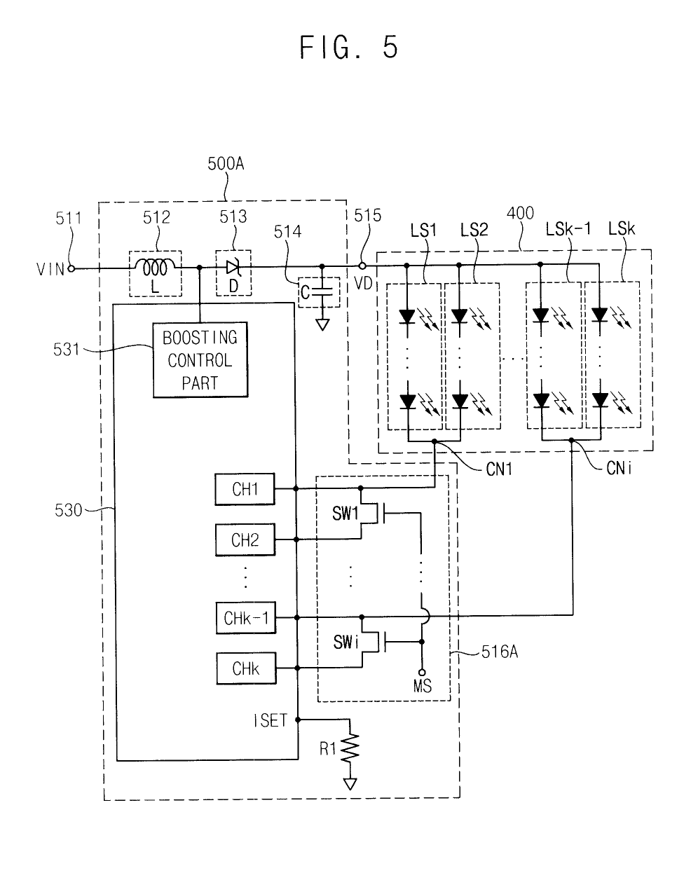

FIG. 5 is a block diagram of another exemplary embodiment of a light source driving part according to the present invention. The same reference characters have been used in FIG. 5 to refer to the same or like components as those described in greater detail above with reference to FIGS. 1-4, and any repetitive detailed description thereof will hereinafter be omitted.

Referring now to FIGS. 1 and 5, a light source driving part 500A according to another exemplary embodiment includes an input part 511, a boosting part 512, a rectifying part 513, a charging part 514, an output terminal 515, a current adjusting part 516A and an integrated circuit 530. The light source driving part 500 drives light-emitting strings LS, LS2, . . . , LSk, as described above.

As shown in FIG. 5, first terminals of each of the light-emitting strings LS, LS2, . . . , LSk are commonly connected to the output terminal 515, and second terminals of at least two of the light-emitting strings LS, LS2, . . . , LSk are connected to each other, e.g., second terminals of pairs of adjacent light-emitting strings LS, LS2, . . . , LSk are connected to each other, and are then connected to the integrated circuit 530 and the current adjusting part 516A.

The integrated circuit 530 includes a current control terminal ISET and channel terminals CH1, CH2, . . . , CHk. A first current having a first level flows through the current control terminal ISET based on a first resistor R1.

The current adjusting part 516A includes switches SW1, . . . , SWi (where ‘i’ is a natural number).

In an exemplary embodiment, for example, a second terminal of a first light-emitting string LS1 and a second terminal of a second light-emitting string LS2 are connected to a first channel terminal CH1 through a first connection node CN1. Similarly, a second terminal of a (k−1)-th light-emitting string LSk−1 and a second terminal of a k-th light-emitting string LSk are connected to a (k−1)-th channel terminal CHk−1 through an i-th channel terminal CH1, as shown in FIG. 5. More specifically, a second channel terminal CH2 adjacent to the first channel terminal CH1 is electrically connected to the first connection node CN1 through the first switch SW1. Similarly, a k-th channel terminal CHk adjacent to the (k−1)-th channel terminal CHk−1 is electrically connected to an i-th connection node CNi through an i-th switch SWi.

A first electrode of the first switch SW1 is connected to the first connection node CN1, and a second electrode of the first switch SW1 is connected to the second channel terminal CH2 so that a control electrode of the first switch SW1 receives the mode signal MS. Similarly, a first electrode of the i-th switch SWi is connected to the i-th connection node CNi, and a second electrode of the i-th switch SWi is connected to the k-th channel terminal CHk so that a control electrode of the i-th switch SWi receives the mode signal MS.

When the mode signal MS is a low level, the first through i-th switches SW1, . . . , SWi are turned off in response to the mode signal MS having the low level LOW_L. When the first through i-th switches SW1, . . . , SWi are turned off, the first though i-th connection nodes CN1, . . . , CNi are electrically connected to odd numbered channel terminals CH1, . . . , CHk−1, respectively.

The first connection node CN1 is connected to the first channel terminal CH1. Similarly, the i-th connection node CNi is connected to the (k−1)-th channel terminal CHk−1.

The integrated circuit 530 supplies the first current at the first level to the channel terminals CH1, CH2, . . . , CHk, based on the first current at the first level applied to the current control terminal ISET. Thus, the first current at the first level flows through the first to i-th connection nodes CN1, . . . , CNi connected to one respective corresponding channel terminal.

As a result, each of the light-emitting strings LS, LS2, . . . , LSk is driven by the first current at the first level.

When the mode signal MS is a high level, the first through i-th switches SW1, . . . , SWi are turned on in response to the mode signal MS at the high level. When the first through i-th switches SW1, . . . , SWi are turned on, the first through i-th connection nodes CN1, . . . , CNi are respectively connected to odd numbered and even numbered channel terminals CH1, CH2, . . . , CHk−1 and CHk connected in parallel by the first through i-th switches SW1, . . . , SWi.

Specifically, for example, the first connection node CN1 is connected to the first channel terminal CH1 and the second channel terminal CH2 that are connected in electrical parallel with each other. Similarly, the i-th connection node CNi is connected to the (k−1)-th channel terminal CHk−1 and the k-th channel terminal CHk that are connected in electrical parallel with each other.

Thus, the integrated circuit 530 supplies the first current at the first level to all of the channel terminals CH1, CH2, . . . , CHk, based on the first current of the first level applied to the current control terminal ISET. As a result, a second current having a second level that is two times the level of the first level flows through the first through i-th connection nodes CN1, . . . , CNi connected to respective corresponding channel terminals.

As a result, each of the light-emitting strings LS, LS2, . . . , LSk is driven by the second current at the second level.

In an exemplary embodiment, two channel terminals and two light-emitting strings are connected in electrical parallel with each other in a case of a 3D mode so that a current that is increased by two times greater than that in a 2D mode is applied to each of the light-emitting strings, but additional exemplary embodiments are not limited thereto. Specifically, for example, more than two channel terminals and more than two light-emitting strings may be connected to each other so that the current level may be further increased.

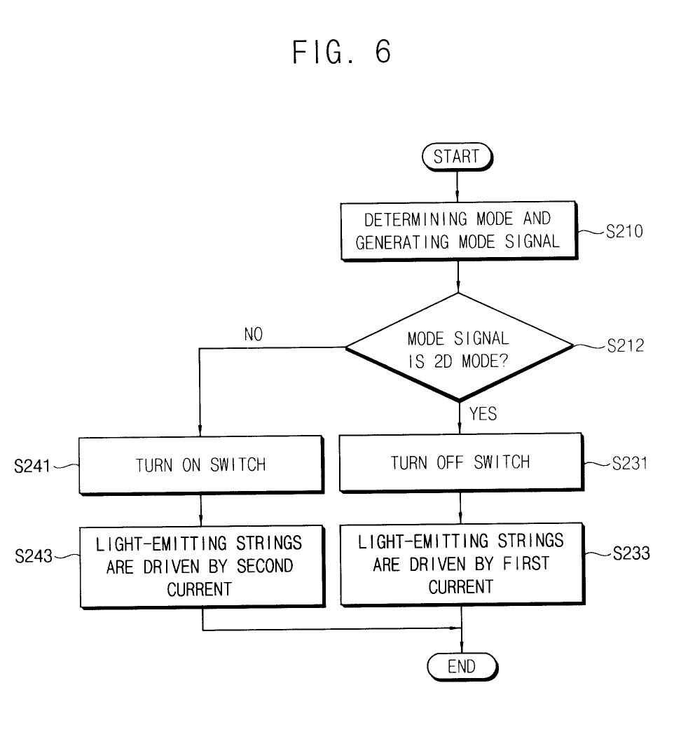

FIG. 6 is a flowchart illustrating another exemplary embodiment of a method of driving a light source apparatus according to the present invention.

Referring to FIGS. 4, 5 and 6, the mode determining part 130 determines an image mode of an image signal, e.g., whether the image signal is a 2D mode image signal or a 3D mode image signal, based on the synchronization signal, to generate a mode signal MS (step S210). Specifically, for example, when a mode of the image signal is a 2D mode, the mode determining part 130 generates the mode signal MS having a low level LOW_L. Alternatively, when the mode of the image signal is a 3D mode, the mode determining part 130 generates the mode signal MS having a high level HIGH_L.

In step S212, it is determined whether the mode signal MS, which is generated in step S210, corresponds to a 2D mode or a 3D mode.

When it is determined that the mode signal MS corresponds to the 2D mode, the mode determining part 130 provides the light source driving part 500 with the mode signal MS at a low level LOW_L. Thus, the mode signal MS at the low level LOW_L is supplied to control electrodes of the switches SW1, . . . , SWi of the current adjusting part 516A.

Thus, the switches SW1, . . . , SWi are turned off in response to the mode signal MS at the low level LOW_L (step S231). When the switches SW1, . . . , SWi are turned off, the first through i-th connection nodes CN1, . . . , CNi are connected to odd numbered channel terminals CH1, . . . , CHk−1. Thus, a first current I_2D at the first level LEV1 is supplied to the first through i-th connection nodes CN1, . . . , CNi. Therefore, each of the light-emitting strings LS1, LS2, . . . , LSk is driven by the first current I_2D at the first level LEV1 (step S233).

In contrast, when it is determined that the mode signal MS corresponds to the 3D mode, the mode determining part 130 provides the light source driving part 500 with the mode signal MS at a high level HIGH_L. Thus, the mode signal MS at the high level HIGH_L is supplied to control electrodes of the switches SW1, . . . , SWi of the current adjusting part 516A.

Thus, the switches SW1, . . . , SWi are turned on in response to the mode signal MS at the high level HIGH_L (step S241). When the switches SW1, . . . , SWi are turned on, the first through i-th connection nodes CN1, . . . , CNi are connected to corresponding odd numbered and even numbered channel terminals CH1, CH2, . . . , CHk−1 and CHk. Thus, a second current I_3D having a second level that is two times the first level LEV1 is supplied to the first through i-th connection nodes CN1, . . . , CNi. Therefore, each of the light-emitting strings LS1, LS2, . . . , LSk is driven by the second current I_3D having the second level LEV2 (step S243).

As a result, in the 3D mode, the light-emitting strings LS1, LS2, . . . , LSk are driven by a second current I_3D having a higher current level than in the 2D mode, so that light having a higher luminance than in the 2D mode is generated by the light source part 400.

As described herein, according to exemplary embodiments of the present invention, in a display apparatus for displaying a 2D image and a 3D image, a current level of a light-emitting string, which corresponds to a mode for displaying the 3D image, is greater than a current level of the light-emitting string, which corresponds to a mode for displaying the 2D image. As a result, display quality of the 3D image is significantly enhanced.

The present invention should not be construed as being limited to the exemplary embodiments set forth herein. Rather, these exemplary embodiments are provided so that this disclosure will be thorough and complete and will fully convey the concept of the present invention to those skilled in the art.

Moreover, while the present invention has been particularly shown and described with reference to exemplary embodiments thereof, it will be understood by those of ordinary skill in the art that various changes in form and details may be made therein without departing from the spirit or scope of the present invention as defined by the following claims

What is claimed is:

1. A method of driving a light source including a light source part, the method comprising:
determining whether an image signal is a two-dimensional mode image signal or a three-dimensional mode image signal to generate a mode signal;
adjusting a level of a current to be applied to the light source part in response to the mode signal to generate an adjusted current; and
driving the light source part using the adjusted current.

2. The method of claim 1, wherein the adjusting the level of the current to be applied to the light source part comprises:
adjusting a first current to have a first level when the mode signal is a two-dimensional mode; and
adjusting a second current to have a second level, which is greater than the first level, when the mode signal is a three-dimensional mode.

3. The method of claim 1, wherein the light source part comprises a light-emitting string including light-emitting diodes.

4. The method of claim 1, wherein
the light source part comprises light-emitting strings connected in electrical parallel with each other, and
each string includes light-emitting diodes connected in electrical series with each other.

5. The method of claim 1, further comprising selectively opening and closing a first shutter and a second shutter of an eyeglasses part when the image signal is the three-dimensional mode image signal.

6. The method of claim 5, further comprising:
temporally dividing the three-dimensional mode image signal into a left-eye image and a right-eye image; and
displaying temporally divided images using light provided from the light source part.

7. The method of claim 6, wherein the displaying the temporally divided images comprises:
opening the first shutter and closing the second shutter when the left-eye image is displayed; and
closing the first shutter and opening the second shutter when the right-eye image is displayed.

8. A display apparatus comprising:
a mode determining part which determines whether an image signal is a two-dimensional mode image signal or a three-dimensional mode image signal to generate a mode signal;
a light source part comprising a light-emitting string including light-emitting diodes; and
a light source driving part which adjusts a level of a current applied to the light source part in response to the mode signal to drive the light-emitting string using an adjusted current.

9. The display apparatus of claim 8, wherein the light source driving part comprises:
a current adjusting part which adjusts the level of the current in response to the mode signal; and
an integrated circuit electrically connected to a first terminal of the light-emitting string, wherein the integrated circuit supplies the adjusted current to the light-emitting string.

10. The display apparatus of claim 9, wherein
the integrated circuit comprises a current control terminal, and
the current adjusting part comprises:
a first resistor connected to the current control terminal;
a switch including a control electrode which receives the mode signal and
a first electrode connected to the first resistor; and
a second resistor connected to a second electrode of the switch.

11. The display apparatus of claim 10, wherein
the switch is turned off to supply a first current having a first level based on the first resistor to the current control terminal when the mode signal is a two-dimensional mode, and
the integrated circuit supplies the first current having the first level to the light-emitting string.

12. The display apparatus of claim 11, wherein
the switch is turned on to supply a second current having a second level based on the first resistor and the second resistor, which is connected in electrical parallel with the first resistor, to the current control terminal when the mode signal is a three-dimensional mode, and
the integrated circuit supplies the second current having the second level to the light-emitting string.

13. The display apparatus of claim 12, wherein the second level is greater than the first level.

14. The display apparatus of claim 9, further comprising a plurality of light emitting strings, wherein
the integrated circuit comprises:
a first channel terminal connected to a connection node which connects a first light-emitting string of the plurality of light emitting strings and a second light-emitting string of the plurality of light emitting strings; and
a second channel terminal disposed adjacent to the first channel terminal,
the current adjusting part comprises a switch including a first electrode and a second electrode,
the first electrode is connected to a control electrode which receives the mode signal and the connection node, and
the second electrode is connected to the second channel terminal.

15. The display apparatus of claim 14, wherein the switch is turned off to electrically connect the connection node and the first channel terminal when the mode signal is a two-dimensional mode, and
the integrated circuit supplies a first current having a first level to the first light-emitting string and the second light emitting string that are electrically connected to the connection node.

16. The display apparatus of claim 15 wherein the switch is turned on to connect to the first channel terminal and the second channel terminal in electrical parallel when the mode signal is a three-dimensional mode, and
the integrated circuit supplies a second current having a second level to the first light-emitting string and the second light emitting string.

17. The display apparatus of claim 8, further comprising:
a display panel which displays a two-dimensional image when the mode signal is a two-dimensional mode, and which displays a three-dimensional image when the mode signal is a three-dimensional mode;
an eyeglasses part comprising a left-eye lens part including a first shutter and a right-eye lens part including a second shutter; and
a shutter control part selectively opening and closing the first shutter and the second shutter when the three-dimensional image is displayed on the display panel.

18. The display apparatus of claim 17, wherein
the display panel temporally divides the image signal into a left-eye image and a right-eye image to display temporally divided images when the three-dimensional image is displayed on the display panel,
the shutter control part opens the first shutter and closes the second shutter when the left-eye image is displayed on the display panel, and
the shutter control part closes the first shutter and opens the second shutter when the right-eye image is displayed on the display panel.
